(19) United States
(12) Patent Application Publication
(10) Pub. No.: US 2014/0165825 A1
(43) Pub. Date: Jun. 19, 2014

(54) TRIBO SYSTEM FOR A PISTON UNIT AND HYDROSTATIC RADIAL PISTON ENGINE EQUIPPED THEREWITH

(71) Applicant: Robert Bosch GmbH, Stuttgart (DE)

(72) Inventors: Khaled Tibari, Witten (DE); Jan Fischer, Reutlingen (DE)

(73) Assignee: Robert Bosch GmbH, Stuttgart (DE)

(21) Appl. No.: 14/107,311

(22) Filed: Dec. 16, 2013

(30) Foreign Application Priority Data
Dec. 17, 2012 (DE) 10 2012 223 348.2

(51) Int. Cl. F16J 1/00

(52) U.S. Cl. CPC F16J 1/00
USPC 92/172

(57) ABSTRACT

A tribosystem for a piston unit includes the piston unit having a piston and at least one rolling body mounted rotatably in a rolling-body receptacle of the piston. The rolling-body receptacle is substantially comprised of a bearing material having a PEEK/PTFE matrix. A surface of the at least one rolling body is polished.

This application claims priority under 35 U.S.C. §119 to patent application no. DE. 10 2012 223 348.2, filed on Dec. 17, 2012 in Germany, the disclosure of which is incorporated herein by reference in its entirety.

### BACKGROUND

The disclosure relates to a tribo system for a piston unit according to the description below and to a hydrostatic radial piston engine equipped therewith, having the features described below.

It is known that tribological systems, which are also designated in brief as tribo systems and are familiar to specialists under this name, are used in mechanical engineering and precision mechanics to describe the interaction of bodies which are in contact with one another and move in relation to one another. In particular, a tribo system serves in mechanical engineering to describe the friction and wear of bodies which interact by mutual contact with themselves and, if appropriate, with intermediate materials. In this case, the intermediate material employed may be, for example, a lubricant.

It is known, further, that, for example in radial piston engines, piston units are used in which a piston guided in a cylinder is supported via a rolling body mounted in the piston on a stroke curve surrounding the piston unit. In this case, the cylinder receiving the piston may be part of a rotating cylindrical body which rotates in relation to the fixed stoke curve. Such a radial piston engine, which has a multiplicity of piston units, is known, for example, from DE 40 37 455 C1.

One disadvantage of such piston units is that friction occurs between the piston and the rolling body cooperating with it and said friction reduces the efficiency of a radial piston engine and, in particular, its start-up efficiency.

Some applications are therefore known in which the efficiency of a radial piston engine is to be improved by hydrostatic pressure relief between the piston and rolling body. The aim in this case is to reduce the frictional force between a piston and a rolling body during running operation, that is to say during the working strokes. Such an application is known, for example, from DE 10 2010 032 058 A1. The disadvantage of this is that such pressure relief does not bring about any insignificant improvement in the start-up efficiency and, furthermore, entails relatively high production costs.

By contrast, the object on which the disclosure is based is to provide a tribo system for a piston unit, in which the start-up efficiency of the piston unit can be increased by means which are structurally as simple as possible.

This object is achieved by means of a tribo system for a piston unit, having the features described below, and by means of a radial piston engine with such a piston unit, having the features described below.

Advantageous developments of the disclosure are specified below.

### SUMMARY

The tribo system according to the disclosure is provided for a piston unit, the piston unit having a piston and at least one rolling body mounted rotatably in a rolling-body receptacle of the piston. According to the disclosure, at least one surface of the at least one rolling body is polished.

By means of such a tribological system, designated in brief as a tribo system, the friction between the bearing shell and the rolling body is markedly reduced and therefore the start-up efficiency of the piston unit is significantly increased. It thus became apparent that the start-up efficiency of a radial piston engine of the type described in the introduction, equipped with such a piston unit, can be increased from about 60 to 65% to 70% and above. The polishing of the rolling body may in this case take place by means of a conventional manufacturing method which gives rise to a sufficiently high surface quality of the rolling body to be polished. In this case, only that surface of the rolling body which comes into contact directly with the rolling-body receptacle or the entire surface of the rolling body may be polished.

In an especially preferred development of the disclosure, the composite material employed as bearing material is a composite plastic and/or composite metal material. Such a composite material is distinguished by accurately adjustable properties in terms of its wear resistance and its sliding properties. In particular, the combination of the polished rolling body and of the bearing material employed, which has a composite plastic and/or composite metal material, has in this case proved to be especially advantageous.

In an advantageous development of the disclosure, the composite plastic and/or composite metal material of the bearing material has a PEEK/PTFE matrix. The use of a bearing material with a PEEK/PTFE matrix is distinguished by especially good wear resistance and an especially low coefficient of friction. Furthermore, this bearing material is preeminently suitable for use in highly dynamic applications. An example of such a bearing material is the sliding material HX™ of the company GGB Bearing Technology, which has proved to be especially expedient for the disclosure.

In an advantageous development of the disclosure, the at least one polished rolling body or the polished rolling-body surface has a maximum smoothing depth Rpmax of 0.20±0.05 μm, this value being composed of the nominal dimension to be made and of a manufacturing tolerance. A rolling body with a surface quality provided in this way brings about an especially low coefficient of friction and therefore a significant increase in the start-up efficiency of the piston unit or of a radial piston engine equipped therewith.

It has proved to be advantageous if the polished rolling-body surface has a mean roughness value Ra of 0.03±0.01 μm, this value being composed of the nominal dimension to be made and of a manufacturing tolerance. The coefficient of friction can be lowered even further as a result of such high surface accuracy.

Further, too, the start-up efficiency of a piston unit can be increased if the polished rolling body or the polished rolling-body surface has a reduced peak height Rpk of 0.03±0.02 μm, this value being composed of the nominal dimension to be made and of a manufacturing tolerance.

Advantageously, for a further increase in the start-up efficiency of a piston unit, there may be provision whereby the polished rolling-body surface has a core peak-to-valley height Rk of 0.15±0.01 μm, this value being composed of the nominal dimension to be made and of a manufacturing tolerance.

In an advantageous development of the disclosure, the polished rolling-body surface has an averaged groove depth Rvk of 0.06±0.02 μm, this value being composed of the nominal dimension to be made and of a manufacturing tolerance. A rolling-body surface configured in this way increases the start-up efficiency of a piston unit even further.

It is advantageous if the polished rolling-body surface has a material fraction Rmr of 30±10%, measured at a cutting depth of −0.05 μm. This value Rmr, designated as material fraction, is defined according to DIN EN ISO 4287 and describes the material distribution of a surface roughness profile from outside in the direction of depth.

In an advantageous configuration variant of the disclosure, the at least one polished rolling-body may be configured as a roller. Preferably, the roller has a (circular-) cylindrical shape. Alternatively to this, load-relieved parallel rolling bodies, such as are known from the prior art, may also first be polished and be used instead of the roller. By load-relieved parallel rolling bodies being employed, the service life of a stroke curve of a radial piston engine can be increased.

For especially beneficial manufacture or production of the piston, it has proved advantageous if the rolling-body receptacle is configured as a separate bearing shell, that is to say one formed separately from the piston. Thus, the bearing material having the PEEK/PTFE matrix or the entire piston can be individually manufactured even more cost-effectively and subsequently assembled together.

In addition, the tribosystem according to the disclosure may also be improved additionally by lubrication with an oil, in particular a hydraulic oil. An oil with the designation Tellus 46 from the company Shell has proved especially suitable for this purpose. The start-up efficiency can be increased even further by such lubrication.

Especially advantageously, the tribosystem according to the disclosure and a piston unit equipped therewith can be employed in a radial piston engine described in the introduction or used in such a radial piston engine. In particular, by means of such a tribosystem, the start-up efficiency of the radial piston engine equipped therewith can be increased significantly, without the service life of the piston unit or of the radial piston engine equipped therewith being reduced.

### BRIEF DESCRIPTION OF THE DRAWINGS

An advantageous exemplary embodiment of a tribosystem according to the disclosure is explained in more detail below by means of a drawing in which:

FIG. 1 shows part of a radial piston engine in a lateral section with a piston unit which has a tribosystem according to the disclosure, and

FIG. 2 shows, illustrated by way of example, a piston unit from FIG. 1 with a tribosystem according to the disclosure in a top view.

Identical components are given the same reference symbols throughout in the figures.

### DETAILED DESCRIPTION

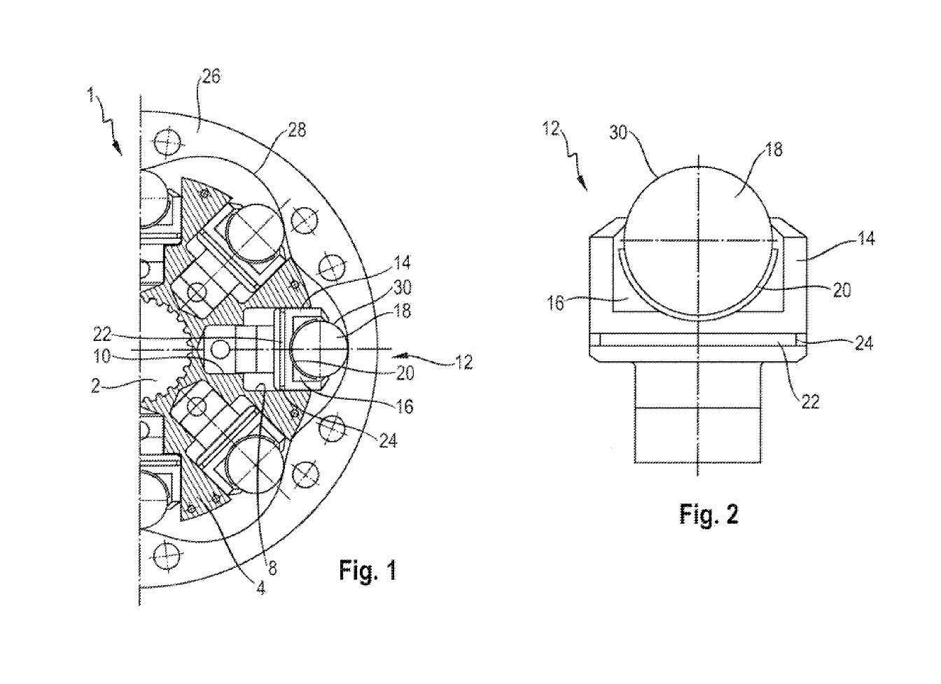

FIG. 1 shows an exemplary embodiment of a radial piston engine 1 described in the introduction, in an axial longitudinal section. In this exemplary embodiment, the radial piston engine 1 is a radial piston motor with external piston support which is usually used as a hydraulic motor. The precise functioning of such a radial piston engine is described, for example, in DE 40 37 455 C1.

The radial piston engine 1 has a centrally arranged shaft 2, by means of which an element fastened thereto can be driven. The shaft 2 is driven by a rotating rotor 4 in which a multiplicity of cylinders 6 are formed. In this exemplary embodiment, the radial piston engine 1 has exactly eight cylinders 6, of which FIG. 1 illustrates only three completely and in each case half of a further two. The cylinders 6 are arranged radially or in a star-shaped manner about the shaft 2. Moreover, each cylinder 6 has a main bore 8 and a radially stepped-back guide bore 10, in which a piston unit 12 is in each case received movably.

Each of the piston units 12 has a piston 14 which in this exemplary embodiment is a step piston. Each piston 14 has at a radially outer end a recess 16 which serves as a rolling-body receptacle and which can receive, rotatably mounted, a rolling-body 18 configured as a roller. In this exemplary embodiment, however, a bearing shell 20 separated from the piston 14 is arranged in the recess 16 and functions as a rolling-body receptacle between the rolling body 18 and the piston 14. The bearing shell 20 is fastened to the piston 14 and is manufactured from a bearing material which has a PEEK/PTFE matrix. The bearing material used here is available under the tradename HX™ from the company GGB Bearing Technology. Each piston 14 has, further, a peripheral groove 22 which is arranged underneath the rolling-body receptacle 16, that is to say further inward than the latter in the radial direction. A piston ring 24 serving as a sealing element is received in the peripheral groove 22.

The radial piston engine 1 has, further, a fixed wave-shaped stroke curve 26 which has a profiled curved track 28 and which is arranged peripherally around the rotor 4 and therefore also around the cylinders 6, together with the piston units 12. This arrangement makes it possible that the rolling bodies 18 are supported on the curved track 28 of the stroke curve 26 and roll on the stroke curve 26 during a rotational movement of the rotor 4. The piston units 12 consequently execute an oscillating movement within the cylinders 6.

The tribosystem according to the disclosure is described below by means of FIG. 2 which shows by way of example a piston unit 12 from FIG. 1. As explained above, the rolling body 18 configured as a roller is received, mounted, in the bearing shell 20 manufactured from a bearing material having a PEEK/PTFE matrix. The rolling body 18 has a surface 30 which, in the installed state, is in direct contact with the bearing shell 20 and with the stroke curve 26. In order to achieve as low a frictional resistance as possible between the rolling body 18 and the bearing shell 20 and also the stroke curve 26, the surface 30 of the rolling body 18 is polished. In this exemplary embodiment, the polished surface 30 is restricted to the surface area of the circular-cylindrical rolling body 18.

In particular, the surface 30 of the rolling body 18 is polished by manufacture so that it has a maximum smoothing depth Rpmax of 0.20±0.05 μm, a mean roughness value Ra of 0.03±0.01 μm and a reduced peak height Rpk of 0.03±0.02 μm. The core peak-to-valley height Rk amounts to 0.15±0.01 μm and the averaged or reduced groove depth Rvk is specified at 0.06±0.02 μm. Moreover, the polished rolling-body surface has a material fraction Rmr of 30±10%, measured at a cutting depth of −0.05 μm. Each of the individual surface quality specifications listed above already enables the coefficient of friction to be reduced. Only for an especially low coefficient of friction can the surface 30 of the rolling body 18 be polished in such a way that all the specifications listed above are achieved.

Thus, a piston 14 with the rolling-body receptacle or with the bearing shell 20, which are manufactured from a bearing material having a PEEK/PTFE matrix, and with the polished rolling body 18 mounted rotatably therein forms a tribosystem according to the disclosure. This tribosystem is distinguished by an especially low coefficient of friction, particularly by a low coefficient of static friction, and thus increases the start-up efficiency of the radial piston engine 1 equipped therewith.

In contrast to the exemplary embodiment illustrated, the disclosure can be modified in many different respects. For example, the rolling body 18 configured as a roller may also be configured in the form of load-relieved parallel rolling bodies in order thereby to increase the service life of the stroke curve 26.

It is conceivable, further, that the tribosystem according to the disclosure is additionally improved by the use of an oil, such as, for example, a hydraulic oil with the designation Tellus 46 of the company Shell.

Furthermore, the piston unit 12 with the tribosystem according to the disclosure does not necessarily have to be employed in a radial piston engine 1 with external piston support, but may also be employed advantageously in other technical applications. In particular, an application in radial piston engines with another form of construction having no external piston support may also be envisaged. Use in technical systems which are not radial piston engines is also conceivable.

A tribosystem of a piston unit is disclosed, the piston unit having a piston and at least one rolling body mounted rotatably in a rolling-body receptacle of the piston. According to the disclosure, the (Farrad) rolling-body receptacle is manufactured from a bearing material having a PEEK/PTFE matrix and a surface of the at least one rolling body is polished. Furthermore, a radial piston engine which has a piston unit with a tribosystem according to the disclosure is disclosed.

What is claimed is:

1. A tribosystem for a piston unit, comprising:
the piston unit, including:
a piston having a rolling-body receptacle; and
at least one rolling body mounted rotatably in the rolling-body receptacle,
wherein a surface of the at least one rolling body is polished.

2. The tribosystem according to claim 1, wherein the rolling-body receptacle is substantially comprised of a bearing material including at least one of a composite plastic material and a composite metal material.

3. The tribosystem according to claim 2, wherein the at least one of the composite plastic material and the composite metal material of the bearing material has a PEEK/PTFE matrix.

4. The tribosystem according to claim 1, wherein the polished rolling-body surface has a maximum smoothing depth of 0.20±0.05 μm.

5. The tribosystem according to claim 1, wherein the polished rolling-body surface has a mean roughness value of 0.03±0.01 μm.

6. The tribosystem according to claim 1, wherein the polished rolling-body surface has a reduced peak height of 0.03±0.02 μm.

7. The tribosystem according to claim 1, wherein the polished rolling-body surface has a core peak-to-valley height of 0.15±0.01 μm.

8. The tribosystem according to claim 1, wherein the polished rolling-body surface has an averaged groove depth of 0.06±0.02 μm.

9. The tribosystem according to claim 1, wherein the polished rolling-body surface has a material fraction of 30±10%, measured at a cutting depth of −0.05 μm.

10. The tribosystem according to claim 1, wherein the at least one polished rolling body is configured as a roller.

11. The tribosystem according to claim 1, wherein the rolling-body receptacle is configured as a separate bearing shell.

12. The tribosystem according to claim 1, wherein the piston is a step piston.

13. A hydrostatic radial piston engine, comprising:
at least one piston unit having a tribosystem, the at least one piston unit including:
a piston having a rolling-body receptacle; and
at least one rolling body mounted rotatably in the rolling-body receptacle,
wherein a surface of the at least one rolling body is polished.
